(19) United States
(12) Patent Application Publication
(10) Pub. No.: US 2004/0066926 A1
(43) Pub. Date: Apr. 8, 2004

(54) Computer telephony integration

(76) Inventors: Robert G Brockbank, Woodbridge (GB); Derek J Emerson, Ipswich (GB)

Correspondence Address: Nixon & Vanderhye, 8th Floor, 1100 North Glebe Road, Arlington, VA, 22201-4714, US

(21) Appl. No.: 10/468,917

(22) PCT Filed: Mar. 14, 2002
(86) PCT No.: PCT/GB02/01099

(51) Int. Cl. H04M 3/42; H04L 9/00; G06F 11/30

(52) U.S. Cl. 379/207.13; 713/202

(57) ABSTRACT

In a Computer Telephony Integration environment, a method of, and system for, registering the identity of a telephone terminal in association with the identity of a computer terminal, in which a host computer requests a user, via a screen display on the computer of his workstation, to declare the number of the telephone which he wishes to be registered in association with his computer. When the user answers a call made to that telephone from the CTI-enabled PBX by command of the host computer (the CTI server of the registration system) and dials or speaks a codeword, this is received at the PBX and reported to the host computer, and the telephone is registered as associated with the computer terminal provided that the reported codeword matches the codeword provided to the user. By calling the telephone presumed to be associated with the computer and verifying the association upon successful comparison of the codewords, the registration process is independent of the telephone identifying itself via CLI to the registration system and thus the user can be situated in a remote country, or connected to a PSTN which does not support the transmission of CLI.

This invention relates to a Computer Telephony Integration (CTI) environment wherein, for example, a user can enter a command at his computer terminal for a call to be made to a destination number.

Examples of such CTI environments are disclosed in the articles “Introduction to Computer Telephony Integration”, by A. Catchpole, G. Crook, and D. Chesterman, British Telecommunications Engineering, July 1, 995; “Computer Telephony Integration—The Meridian Norstar”, by A. Catchpole, British Telecommunications Engineering, October 1995; “Computer Telephony Integration—The Meridian 1 PBX”, by P. Johnson, A. Catchpole, and L. Booton, British Telecommunications Engineering, July 1996; “Callscape—Computer Telephony Integration for the Small Business”, by G. Hillson, G. Hardcastle, and M. Allington, British Telecommunications Engineering, January 1997, “Call Centres—Doing Business by Telephone” by M. Bonner, British Telecommunications Engineering, July 1994, and “ClickDial, Web-Enabled CTI”, by Robert Brockbank, Gary Crook and Derek Emerson, British Telecommunications Engineering, April 1999.

CTI is particularly useful in call centres, and International Application Number PCT/GB96/00727 (Publication Number WO 96/31044) in the name of BRITISH TELECOMMUNICATIONS public limited company (BT) discloses an ACD suite in a call centre such as BT's national telephone account management operation.

In such a call centre, if an agent wants to be connected to the number of a target customer, for example a potential customer in a telesales mode of the call centre, the agent sends a “MakeCall” command to the call control apparatus. If the agent is allowed to specify a desired number, referred to as the target number, then he will insert this into the command. Otherwise, upon receipt of a MakeCall command that does not contain a target number, the call control apparatus will generate a suitable number using a sales program as is known in the art. The call control apparatus will then send to the switching system a command containing a target number and the number of an extension which is to be joined to the external call to the target customer. The extension and the target customer are now connected together by the switching system so that the agent may speak to the target customer. Depending upon the control program of the switching system, this is effected by any one of a number of known ways. For example, in one way the switching system makes an external call to the supplied target number, and, when the target customer answers, then makes a call to the extension, and joins the two calls when the agent answers the call to the extension, and in another way the switching system makes a single call from the extension to the target number.

If the call control apparatus has registered an association between the agent and an extension number other than the number of the telephone terminal that is associated with the computer terminal to form a workstation, as is known in the art, then the wrong agent will be connected to the target customer.

In accordance with a first aspect of the present invention, there is provided a method of registering the identity of a telephone terminal in association with the identity of a computer terminal, the method comprising the steps of:

receiving from a user of a computer terminal a telephone number of a telephone terminal which that user wishes to have registered in association with the identity of that computer terminal;

making a call to that received telephone number;

providing to the user, via that computer terminal, a codeword;

answering by the user the call made to that received telephone number;

receiving data via that telephone terminal after that call has been answered;

comparing the received data with the provided codeword; and

if there is a match, registering that received telephone number in association with the identity of that computer terminal.

Preferably, there are included the steps of starting a timeout when the call is made, and sending a termination message to that computer terminal in the event that the timeout expires before the call is answered.

There may be included the step of checking whether the received telephone number is a member of a list of authorised telephone numbers for that user. This is advantageous in situations where the user's telephone is connected to a remote PBX and it is desired to check whether the received number is within the known range of numbers allocated to that PBX.

Preferably, the user provides said telephone number via his computer terminal in response to an invitation sent to that computer terminal, and more preferably the codeword is provided in combination with the invitation.

The invitation may be sent in response to a failure to receive at a predetermined destination number a calling line identity, referred to herein as a CLI, in respect of that telephone terminal when the user had dialled that predetermined destination number.

In accordance with a second aspect of the present invention, there is provided a system for registering the identity of a telephone terminal in association with the identity of a computer terminal, the system comprising:

means to receive from a user a telephone number of a telephone terminal which that user wishes to have registered in association with the identity of that computer terminal;

means responsive to receipt by the receiving means of that telephone number to make a call to that received telephone number;

means to provide to the user, via that computer terminal, a codeword;

means to receive data provided via that telephone terminal;

means to compare the received data with the provided codeword; and

means responsive to a match between the received data and the provided codeword to register that received telephone number in association with the identity of that computer terminal.

Preferably, there are included means responsive to the making of the call to start a timeout, and means responsive to the expiration of the timeout to send a termination message to that computer terminal.

There may be included means for checking whether the received telephone number is a member of a list of authorised telephone numbers for that user.

There may be included means for sending to that computer terminal an invitation for the user to provide said telephone number via his computer terminal, and said means to receive from a user a telephone number may be arranged to receive said telephone number provided via that computer terminal.

Preferably, the means for providing the codeword is arranged to provide the codeword in combination with the invitation.

Preferably, the means for sending an invitation is responsive to a failure to receive at a predetermined destination number a calling line identity in respect of that telephone terminal when the user had dialled that predetermined destination number.

The secure registration in accordance with the present invention of a telephone terminal with a computer terminal can be invoked by a user at any workstation, and is not dependent upon the ability of the telephone terminal at that workstation, or of the local switching system, to send the corresponding CLI. Thus, a user can be resident remotely from the registration system, and connected to a remote public switched telephone network (PSTN) which does not permit the transmission of a CLI, possibly in a different country.

The secure registration in accordance with the present invention also makes it difficult to effect a fraudulent registration of a telephone terminal, other than that which is normally associated with a user's computer terminal, since it will normally be only the user at the computer terminal who will know the codeword, e.g. from the screen display, and who will answer the registration call made from the registration system of the present invention to his chosen telephone terminal, and send the codeword via that telephone terminal, which may be a conventional land line telephone within easy reach of his computer terminal in his study at home, or it may be his mobile telephone.

The registered association of a telephone terminal and a computer terminal also makes receipt of incoming calls secure. In one example where a remote originator wants to establish a telephone call to a desired recipient, that remote originator can send a request for registration information to an application running on a desired recipient's computer terminal. The computer terminal stores a registration record, and the application accesses that record and sends back to the remote originator the telephone number retrieved from that registration record. In other example, the remote originator knows the address of a central server storing such registration records and also knows the identity (IP address) of the computer terminal of the desired recipient, but does not know the desired recipient's telephone number . The remote originator sends to the central server a MakeCall request containing that IP address, and the central server looks up the association and commands the remote originator's local switch to make a call to the desired recipient's telephone number. In this way, the desired recipient's telephone number is not provided directly to the remote originator, and can remain secret from the remote originator.

Specific embodiments of the invention will now be described by way of example with respect to the accompanying drawing in which:

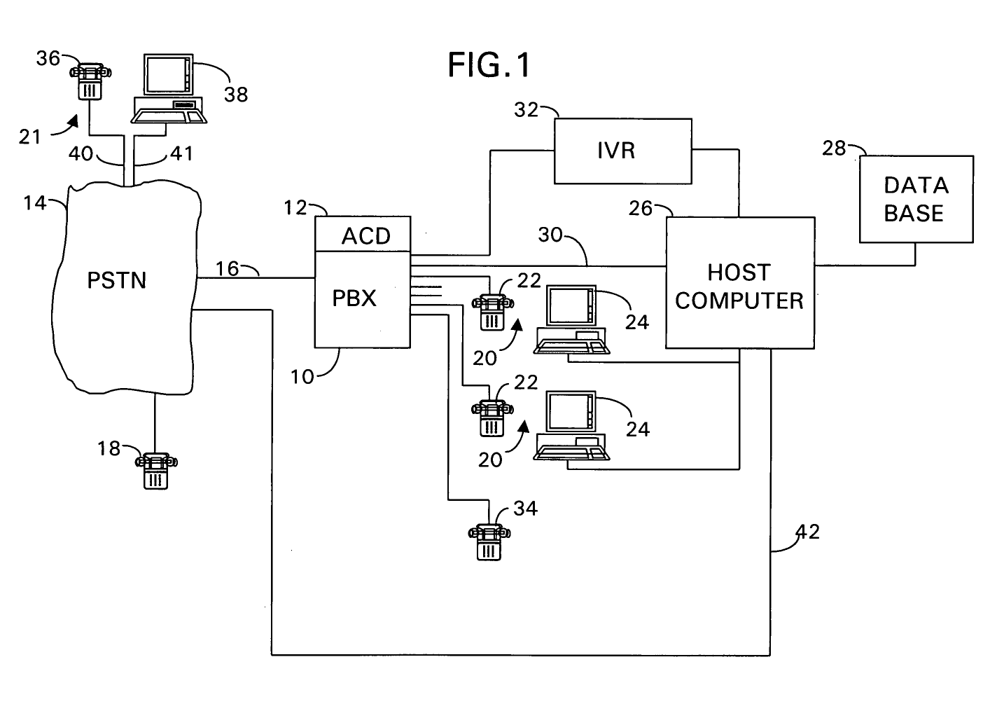

FIG. 1 shows an ACD suite embodying the present invention.

In FIG. 1 the ACD suite is of a type of ACD suite used in a call centre such as BT's national telephone account management operation. This type of ACD suite and its operation is described in detail in International Application Number PCT/GB96/00727 (Publication Number WO 96/31044) and for the purposes of the present invention this type of ACD suite will be described only briefly in respect of its component parts, and relevant operational characteristics.

The suite comprises a PBX 10, constituting a switching system of the present invention, associated with an ACD system 12 and connected to a Public Switched Telephone Network (PSTN) 14 by a thirty two timeslot 2.048 Mbit/second transmission link 16, of which, as is known in the art, timeslots T1 to T15, and T17 to T31 are speech channels, and timeslots T0 and T16 are respectively a frame synch and a common channel signalling channel.

Customers, represented by telephone terminal 18, can make calls to the call centre by dialling the published directory number, also referred to as a national number or a destination terminal number, of the call centre. These incoming calls are received at the PBX 10 and placed in a queue by the ACD system 12. The ACD system 12 in known manner allocates the call at the head of that queue to a selected one of a plurality of call centre agent positions. The agents are either call centre-based at positions 20 (also referred to as workstations), each comprising a telephone terminal 22 (also referred to as an ACD turret) and an associated computer terminal 24, or they are teleworking agents, represented by remote workstation 21 comprising telephone terminal 36 and associated computer terminal 38.

Each computer terminal 24 is constituted by a personal computer, commonly referred to as a PC, and is connected to a host computer 26 having an associated database 28 and connected to the PBX 10 via a CTI link 30. An interactive voice response system (IVR) 32 is connected to a port of the PBX 10 and to the host computer 26, and is arranged to obtain data from customers, and teleworking agents, and to pass this to the host computer 26 for processing as appropriate. In FIG. 1 only two workstations 20 are shown although in a call centre of a large company there may be in the region of a hundred workstations 20. In variants, the computer terminals 24 are dumb terminals and rely on the processing power of the host computer 26.

The location of a remote workstation 21 could be one of a variety of places. For the purpose of this example it will be assumed that the remote workstations 21 are located in the private residences of teleworking agents, the telephone terminal 36 being connected to the PSTN 14 via a respective local line 40, and the computer terminal 38 being connected to the PSTN 14 via a respective local line 41 and a modem (not shown). The host computer 26 is connected to the PSTN 14 via a local line 42 and a modem (not shown). Alternatively, instead of the local line 42, the connection may be via a voice channel through the PBX 10.

When an agent starts a work period at a workstation 20, or at a remote workstation 21, he or she logs on to the ACD system 12 using the TouchTone (Registered Trade Mark) keypad of the telephone terminal 22, 36. Alternatively, the log on procedure can be performed via the computer terminal 24, the host computer 26 and the CTI link 30, or via the computer terminal 38, the PSTN 14, the link 42, the host computer 26 and the CTI link 30.

The host computer 26, constituting a call control apparatus of the present invention, is programmed to monitor activity of the call control processor (not shown) of the PBX 10 and to send command messages to the call control processor as will be described below.

The host computer 26 contains a list of the identities of, say, ten virtual terminals 34 which are designated as virtual turrets for teleworking only and have no physical existence. In this example, the PBX 10 is configured so that it has a set of port identities corresponding to the identities of the virtual terminals 34, these port identities not being associated with any physical ports of the PBX 10 and being merely virtual ports. In other words, the call control processor will command connection of the ringing current generator to a selected virtual port under the control of the ACD 12, and cease the connection under the control of the host computer 26, but the PBX 10 will not be aware that these virtual ports have no physical existence.

In order to support teleworking, the ACD system 12 must still associate a teleworking agent's identity with the identity of what it deems to be an active terminal 22 in the call centre, and the manner in which this is achieved will now be described.

In accordance with the present invention, which is for use in situations where the CLI of the telephone terminal 36 is not received by the PBX 10, for example, the teleworking agent might have invoked withholding of his CLI at his local PSTN switch, or the CLI is not transmissible through the PSTN for any reason, the teleworking agent will activate his computer terminal 38 which will autodial the directory number of the host computer 26. When a connection has been established via the PSTN 14, the teleworking agent logs on to the host computer 26 and initiates a telephone/computer association registration procedure. The host computer 26 receives a computer identity from the computer 38, and in response sends data for a screen display, i.e. a page, including a text entry box, and a text invitation for the teleworking agent to enter the PSTN number, also referred to as the teleworking agent's directory number (DN), of the telephone terminal 36 which he wishes to be registered in association with the computer terminal 38.

The teleworking agent enters his DN in the text entry box, and clicks on a reply button to send this information to the host computer 26, which stores the teleworking agent's DN temporarily in association with the identity of the teleworking agent and the identity of the computer terminal 38.

The host computer 26 now enters a security phase of the registration procedure.

The host computer 26 responds to receipt of the DN from the computer 38 by sending a page including a codeword, CW, in the form of nine randomly generated digits, by instructing the PBX 10 to make a call to the DN, and to connect the IVR 32 to that call for receiving data from the teleworking agent, and by starting a first timeout of a few seconds, e.g. two seconds, just sufficient for one cycle of the conventional alerting (ringing) signal. If the PBX 10 does not report to the host computer 26 that the call has been answered before the first timeout has expired, the host computer 26 instructs the PBX 10 to cancel the call, and to enter a rejection mode. This rejection mode comprises sending an appropriate text message for display on the teleworking agent's computer screen. Thus, it will be understood that this provides a measure of security since the teleworking agent will be expecting the call and will normally be able to answer the call within such a short time period, but if the call has inadvertently been made to another person it is unlikely that it will be answered within that time period.

Assuming that the teleworking agent has answered the call before the expiration of the first timeout, the PBX 10 reports to the host computer 26 that the call has been answered. The host computer 26 then instructs the IVR 32 to play a prompt requesting that the codeword appearing on the computer screen be keyed on the telephone keypad, and starts a second, interdigit, timeout of twenty seconds, i.e. sufficient time for the teleworking agent to read the codeword and key it on the telephone keypad. If the interdigit timeout expires before the host computer 26 receives from the IVR 32 the required number of digits keyed in by the teleworking agent, the host computer 26 instructs the PBX 10 to clear that call to the teleworking agent, and a suitable message is sent for display on the teleworking agent's computer screen.

The host computer 26 compares these received digits with the codeword sent to the computer terminal 38, and if they match confirms the stored association of the received DN with the identity of the computer terminal 38, and sends a further screen display to the computer terminal 38 containing the text message “Thank you. Now please hang up.”, and instructs the IVR 32 to play a corresponding “Thank you” prompt. The DN and computer terminal identity are stored in respective fields of a registration record, and a ninety day validity period is set for that registration record. When that ninety day period has expired, the registration record is marked as invalid.

In a variant, the host computer 26 instructs the IVR 32 to play the “Thank you” prompt without sending the further screen display.

In another variant, at the start of the registration procedure, the host computer 26 refers to the registration record for the computer terminal, reads any existing DN stored in the DN field, and generates a screen display to inform the teleworking agent of the last-registered DN. Included in this screen display is the instruction to choose between options “Use existing registration” or “Change existing registration”. If the teleworking agent selects “Use existing registration”, the registration procedure is not used. In a further variant, an alternative screen display is generated which informs the teleworking agent of the existing registered DN, and instructs the teleworking agent to proceed with the registration procedure as verification of that registration.

If there is no existing DN stored in the DN field, this screen display is not generated, and the normal registration procedure is performed.

In a further variant, the host computer 26 sends a single page which is effectively the combination of the above two pages so that the codeword appears in the same page that requests the teleworking agent to enter his DN in the text entry box.

In a further variant, for enabling the host computer 26 to capture the teleworking agent's DN, the initial screen displayed on the computer 38 includes a registration number, i.e. the network number corresponding to a port of the PBX 10 at which the IVR 32 is connected, and an invitation for the teleworking agent to dial the registration number and to enter on the keypad his DN. The IVR 32 collects any dialled digits and sends them to the host computer 26. So that several teleworking agents can register simultaneously using this procedure, the PBX 10 has a block of directory numbers pre-allocated as registration numbers. Thus, the lowest free registration number, say, will be sent to the first teleworking agent to log on, and the next lowest will be sent to the next teleworking agent to log on, and so on. The IVR 32 has, in this embodiment, four ports and can handle a call on each port simultaneously. When more than four teleworking agents are attempting to register at the same time, the ACD system 12 will queue the calls until earlier registrations have been dealt with. It will be appreciated that the size of the block of pre-allocated directory numbers and the total number of ports allocated to this procedure will depend upon the expected amount of usage.

In a variant, at the completion of the procedure, the host computer 26 sends a cookie, in known manner, to the computer terminal 38, this cookie containing a pointer to the location of the registered association in the database 28.

In another variant, instead of the host computer 26 storing the registration in the database 28, it can send a cookie, in known manner, to the computer terminal 38, this cookie containing the DN in encrypted form. The encrypted DN will be decrypted by the host computer 26 when it is sent by the computer terminal 38 in connection with a MakeCall message or a Call Me message.

In another variant, instead of the host computer 26 sending a cookie containing the DN, it sends a text file containing the DN in encrypted form, which is stored by the computer terminal 38, and sent to the host computer 26 in connection with a MakeCall message or a Call Me message.

As just described, this method of registering the working association of a telephone terminal and a computer terminal is performed at log on of the teleworking agent, i.e. at the start of a working session. In variants, the registration is performed only if the teleworking agent indicates to the host computer 26 that he wants to make a call. Regardless of when registration is performed, it can be persistent or non-persistent. A persistent registration lasts until a de-registration command is entered or a new registration is performed. In this latter case, the registration is semi-permanent, and is changed only when, for example the teleworking agent currently associated with the workstation changes his mobile telephone and has a new number, or the workstation becomes associated with a different teleworking agent who registers his mobile telephone number instead of the out-of-date registration of the superseded agent. A non-persistent registration lasts until de-registration occurs automatically upon termination of the current session.

If the telephone terminal 36 does not have a TouchTone dial, the teleworking agent can speak the digits of the codeword and the IVR 32 will perform voice recognition to identify the spoken digits and send them in digital form to the host computer 26. Instead of the IVR 32, an operator at an operator position of the PBX 10 can listen to the spoken digits and key them into an operator's keypad connected directly, or indirectly, to the host computer 26.

When the teleworking agent has completed the secure registration procedure associating the identity (DN) of his telephone terminal with the identity of his computer terminal, the host computer 26 will now select an available terminal 34 from its list of virtual turrets, associate the teleworking agent's identity with the identity of the selected terminal 34, and send them to the ACD system 12 via the CTI link 30. The host computer 26 now has a record associating the identity of the agent, the identity of the remote terminal, and the identity of the selected terminal 34 and can upon interrogation by the identity of a terminal 34 retrieve the identity of the corresponding remote terminal.

Thus, the list of active agents stored by the ACD system 12 includes an entry for that selected terminal 34 associated with the teleworking agent's identity, and when the ACD system 12 allocates that selected terminal 34 to receive an incoming call, the PBX 10, under the control of the ACD system 12, attempts to connects the call to the corresponding virtual port by issuing instructions for ringing current to be applied to the selected terminal 34, for ringing tone to be applied to the incoming call, and for recording the respective ringing states.

The host computer 26 detects that the PBX 10 has connected a call to a virtual port which is recorded as being a teleworking virtual terminal, and responds by commanding the PBX 10 to treat the selected terminal 34 as having gone off-hook, i.e. as being answered, and thereby cease applying ringing current to it, and to make an outgoing call to the directory number associated with the selected terminal 34 in the record stored in host computer 26, this being the teleworking agent's telephone.

When the host computer 26 detects that the PBX 10 has registered that the remote teleworking agent has answered this outgoing call, the host computer 26 then instructs the PBX 10 to cease ringing tone to the incoming call and to join the incoming call to the outgoing call, by for example a conference bridge.

The ACD system 12 could be an integral part of the call control process of the PBX 10 or could be a separate entity and coupled to the PBX 10 via a suitable link.

In the above scenario, the remote teleworking agent is situated at home. In an alternative scenario, he might be a solitary agent or one of a group of agents connected to a PBX at one of a number of remote sites, say in Belfast or Edinburgh, and the PBX 10 and the host computer 26 are situated at a central site, say in London. In this case, the host computer 26 has access to stored data representing the respective ranges of DNs allocated to the PBXs at the remote sites. Thus, if an agent based in Belfast gives his DN, say 028 90xx yyyy; the host computer 26 checks to see whether this corresponds with the known range of DNs, and proceeds with the registration if it does, or enters the rejection mode if it does not.

The above security timeout would be useful in the situation where an agent in, say, Belfast gives a DN within the numbering range of one of the other PBXs known to the host computer 26, say 0131 xxx yyyy. In this case, the host computer 26 recognises the number as being within the numbering range of the Edinburgh PBX and makes a call to that DN. As mentioned above, it is unlikely that a person at that Edinburgh DN will answer that call within the short timeout, and the host computer 26 will enter the rejection mode.

If that Edinburgh DN has Divert activated, this condition is signalled to the PBX 10 by the PBX at Edinburgh, and passed to the host computer 26, which responds by entering the rejection mode.

The present invention may be used as the basis of a second registration stage in conjunction with a first registration stage in accordance with the invention described in International Application Number PCT/GB99/00983 (Publication Number WO 99/51015). Briefly, this first registration stage invites the teleworking agent to dial a registration number, as referred to above, and to dial a codeword, randomly generated nine digits as described above. The IVR 32 collects any dialled digits and sends them to the host computer 26, and the PBX 10 sends to the host computer 26 any received CLI. If the host computer 26 fails to receive a CLI from the PBX 10, it enters the second stage by sending to the teleworking agent an apology that his CLI was not received, and the invitation, described above, to provide his DN.

In a variant, instead of the second stage starting with the invitation via the computer screen, the IVR 32 is used to deliver a voiced announcement of the invitation text.

The codeword used in this second stage is different from that used in the first stage, but in a variant the same codeword is used.

Although the above description is in respect of a call centre, it will be appreciated that the invention is applicable to any CTI environment involving a computer terminal attached to a host computer.

Furthermore, the invention is not limited to outgoing calls made by user commands via the computer terminal, e.g. by keyboard entry or by clicking, in the usual manner with a mouse, on a number or name displayed on the screen of the computer terminal.

The registered association of a telephone terminal and a computer terminal can be used where the computer terminal is coupled to another such computer terminal via a data link. An example is where the computer terminals are connected for access to the Internet, and a first user has found a Web page relating to a second user and containing a “Call Me” link, the “Me” in this sense meaning the first user. The first user clicks on the “Call Me” link, which causes his computer terminal, referred to as the first computer, to send a “Call Me” message to his Web server, referred to as the first server, containing a cookie containing a pointer to the respective stored registration in a database of the first server. The first server knows the identity, i.e. the network address, of the computer associated with the Web page, referred to as the second computer, and forwards the “Call Me” message to the second computer via a Web server, referred to as the second server, associated with the second computer.

On receipt at the second computer of the “Call Me” message, a screen display is generated to inform the second user that a telephone call to the displayed telephone number has been requested. The second user can now make a conventional call via his telephone terminal to that number. Alternatively, if the second user is associated with a CTI-enabled switching system, he can enter a MakeCall command at the second computer to effect a call to that displayed telephone number.

Another example of CTI environment other than a call centre is a conventional office, provisioned with a telephone terminal and a computer terminal, which does not in itself limit the user to any particular profession or work practice. The computer terminal has a telephone directory program which can be searched by the user, and when a desired telephone number has been found, the user will click his mouse button on the number. This will cause the digital data relating to the displayed number to be sent from the computer terminal, or from its host computer depending upon the arrangement, to a PBX serving the office. The PBX now acts, as described above, and makes a call from the number recorded by the host computer as associated with that computer terminal to the requested number.

In the above described registration procedures the instructions are provided to the user by means of a screen display at his computer terminal. Instead, where a computer terminal has a sound card and loudspeakers, a speech synthesiser can be used to generate “spoken” instructions.

In the above described embodiment and variants of the present invention, the host computer 26 constitutes means to receive from a user a telephone number of a telephone terminal which that user wishes to have registered in association with the identity of that computer terminal; the host computer 26 and the PBX 10 together constitute means responsive to receipt by the receiving means of that telephone number to make a call to that received telephone number; the host computer 26 constitutes means to provide to the user, via that computer terminal, a codeword; the IVR 32 constitutes means to receive data provided via that telephone terminal; and the host computer 26 constitutes means to compare the received data with the provided codeword, and means responsive to a match between the received data and the provided codeword to register that received telephone number in association with the identity of that computer terminal. In the above described embodiment in which the user sends his DN to the host computer 26 via his computer terminal, the host computer 26 constitutes means to receive from a user via the user's computer terminal a telephone number of a telephone terminal which that user wishes to have registered in association with the identity of that computer terminal.

The present invention encompasses both central storage of the respective associations of telephone number and computer identity, e.g. in the database 28 mentioned above, and also distributed storage in, e.g. respective cookies or text files, in the individual users' computer terminals.

It will now be appreciated that the above described invention differs from the disclosure of the above mentioned article “ClickDial, Web-Enabled CTI”, and from that of the International Application Publication Number WO 99/51015, in that hitherto the user who wishes to register for use of the ClickDial service makes an originating call to the registration number, and the PBX sends to the host computer that user's CLI retrieved from the signalling data of the call. In contrast, the present invention provides a registration process for a user who, for whatever reason, cannot use the prior art registration process, and in the present invention, instead of the user originating a call to a registration number, the host computer originates a call to the user at the number at which the user wishes to receive the registration call and which the user has previously notified to the host computer, preferably via the user's computer and a data link. The user has to answer that originating call from the host computer, and then he can provide the codeword.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A method of registering the identity of a telephone terminal in association with the identity of a computer terminal, the method comprising the steps of:
receiving from a user of a computer terminal a telephone number of a telephone terminal which that user wishes to have registered in association with the identity of that computer terminal;
making a call to that received telephone number;
providing to the user, via that computer terminal, a codeword;
answering by the user the call made to that received telephone number;
receiving data via that telephone terminal after that call has been answered;
comparing the received data with the provided codeword; and
if there is a match, registering that received telephone number in association with the identity of that computer terminal.

2. A method as claimed in claim 1, including the steps of starting a timeout when the call is made, and sending a termination message to that computer terminal in the event that the timeout expires before the call is answered.

3. A method as claimed in either claim 1 or claim 2, including the step of checking whether the received telephone number is a member of a list of authorised telephone numbers for that user.

4. A method as claimed in any one of claims 1 to 3, wherein the user provides said telephone number via his computer terminal in response to an invitation sent to that computer terminal.

5. A method as claimed in claim 4, wherein the codeword is provided in combination with the invitation.

6. A method as claimed in either claim 4 or claim 5, wherein the invitation is sent in response to a failure to receive at a predetermined destination number a calling line identity in respect of that telephone terminal when the user had dialled that predetermined destination number.

7. A system for registering the identity of a telephone terminal in association with the identity of a computer terminal, the system comprising:
means to receive from a user a telephone number of a telephone terminal which that user wishes to have registered in association with the identity of that computer terminal;
means responsive to receipt by the receiving means of that telephone number to make a call to that received telephone number;
means to provide to the user, via that computer terminal, a codeword;
means to receive data provided via that telephone terminal;
means to compare the received data with the provided codeword; and
means responsive to a match between the received data and the provided codeword to register that received telephone number in association with the identity of that computer terminal.

8. A system as claimed in claim 7, including means responsive to the making of the call to start a timeout, and means responsive to the expiration of the timeout to send a termination message to that computer terminal.

9. A system as claimed in either claim 7 or claim 8, including means for checking whether the received telephone number is a member of a list of authorised telephone numbers for that user.

10. A system as claimed in any one of claims 7 to 9, including means for sending to that computer terminal an invitation for the user to provide said telephone number via his computer terminal, and wherein said means to receive from a user a telephone number is arranged to receive said telephone number provided via that computer terminal.

11. A system as claimed in claim 10, wherein the means for providing the codeword is arranged to provide the codeword in combination with the invitation.

12. A system as claimed in either claim 10 or claim 11, wherein the means for sending an invitation is responsive to a failure to receive at a predetermined destination number a calling line identity in respect of that telephone terminal when the user had dialled that predetermined destination number.

13. A method of registering the identity of a telephone terminal in association with the identity of a computer terminal, the method being substantially as herein described with reference to the drawing.

14. A system for registering the identity of a telephone terminal in association with the identity of a computer terminal, the system being substantially as herein described with reference to and as shown in the drawing.
